(19) United States
(12) Patent Application Publication
(10) Pub. No.: US 2015/0082889 A1
(43) Pub. Date: Mar. 26, 2015

(54) POST-CRIMP INSPECTION DEVICE USING ULTRASONIC TRANSDUCER

(71) Applicant: Tyco Electronics Corporation, Berwyn, PA (US)

(72) Inventors: Keith Lynn Nicholas, Harrisburg, PA (US); John Dunaway Charlton, Harrisburg, PA (US)

(73) Assignee: Tyco Electronics Corporation, Berwyn, PA (US)

(21) Appl. No.: 14/032,935

(22) Filed: Sep. 20, 2013

(51) Int. Cl. G01N 29/22; G01N 29/04

(52) U.S. Cl. CPC G01N 29/22; G01N 29/04
USPC 73/588

(57) ABSTRACT

A post-crimp inspection device includes first and second arms with an inspection zone being defined between the first and second arms and configured to receive a crimped terminal. At least one of the first and second arms is movable toward the crimped terminal during a testing phase. An ultrasonic transducer is coupled to the first arm. The ultrasonic transducer transmits acoustic signals toward the crimped terminal. A compliant member is positioned between the ultrasonic transducer and the crimped terminal. The ultrasonic transducer is ultrasonically coupled to the crimped terminal via the compliant member. The compliant member may conform to a contour of the terminal. The compliant member may receive, and be ultrasonically coupled to, crimped terminals that are crimped using different crimp tooling.

### BACKGROUND OF THE INVENTION

The subject matter herein relates generally to post-crimp inspection devices using ultrasonic transducers.

Terminals are typically crimped onto wires by means of a conventional crimping press having an anvil for supporting the electrical terminal and a ram that is movable toward and away from the anvil for crimping the terminal. In operation, a terminal is placed on the anvil, an end of a wire is inserted into the ferrule or barrel of the terminal, and the ram is caused to move toward the anvil to the limit of the stroke of the press, thereby crimping the terminal onto the wire. The ram is then retracted to its starting point.

New technologies in ultrasonic monitoring have been proposed for use in crimp quality monitoring. For example, U.S. Pat. No. 7,181,942 to Yost describes an ultrasonic device and method for measuring crimp connections by comparing signals with signals from a previous crimp that was determined to be desirable through destructive testing. Yost describes a method of using the ultrasonic device to recertify the desirability of the crimp connection after its formation by aligning the crimp connector with the same punch and anvil and retransmitting acoustic signals through the crimp connection and comparing the received signal with the signal received when the crimp connection was originally made. Such ultrasonic recertification is problematic because the method requires the use of the same tool using the same punch and anvil to line up with the crimp connector. Because the same tool is used, such tool must be taken off-line and is therefore not being used to create more product. Additionally, such tool typically does not have any way to limit the closing action which may cause further compression or distortion of the crimp connection, leading to inaccurate measurements.

A need remains for a crimp quality monitoring system having improved post-crimp inspection devices and methods.

### BRIEF DESCRIPTION OF THE INVENTION

In an embodiment, a post-crimp inspection device is provided that includes first and second arms with an inspection zone being defined between the first and second arms and configured to receive a crimped terminal. At least one of the first and second arms is movable toward the crimped terminal during a testing phase. An ultrasonic transducer is coupled to the first arm. The ultrasonic transducer transmits acoustic signals toward the crimped terminal. A compliant member is positioned between the ultrasonic transducer and the crimped terminal. The ultrasonic transducer is ultrasonically coupled to the crimped terminal via the compliant member. The compliant member may conform to a contour of the terminal. The compliant member may receive, and be ultrasonically coupled to, crimped terminals that are crimped using different crimp tooling.

Optionally, the compliant member may be applied directly to the ultrasonic transducer. Optionally, the post-crimp inspection device may include a mounting block having a first side and a second side. The ultrasonic transducer may be coupled to the first side and the compliant member may be coupled to the second side. The second side may define an emitting face with the acoustic signals being emitted from the emitting face. The emitting face may have a contour that does not match a contour of the crimped terminal. The compliant member may be applied directly to the emitting face. The compliant member may be elastically deformed against the crimped terminal to match at least a portion of the contour of the crimped terminal. The second side may be concave to focus the acoustic signals inward toward the contact terminal.

Optionally, the ultrasonic transducer may define a first ultrasonic transducer and the compliant member may define a first compliant member. The post-crimp inspection device may include a second ultrasonic transducer coupled to the second arm that receives the acoustic signals and a second compliant member positioned between the second ultrasonic transducer and the crimped terminal. The crimped terminal may be ultrasonically coupled to the second ultrasonic transducer via the second compliant member. Optionally, the first and second compliant members do not touch one another. The crimped terminal may include a top, a bottom, a first side and a second side. The first compliant member may engage the top and the first and second sides. The second compliant member may engage the bottom and the first and second sides.

In another embodiment, a post-crimp inspection device is provided that includes first and second arms with an inspection zone being defined between the first and second arms configured to receive a crimped terminal. At least one of the first and second arms is movable toward the crimped terminal during a testing phase. An ultrasonic transducer assembly is coupled to the first arm. The ultrasonic transducer assembly has a transmitting transducer transmitting acoustic signals toward the crimped terminal. The ultrasonic transducer assembly has an emitting face through which the acoustic signals are emitted. The emitting face has a contour that does not match a contour of the crimped terminal. A compliant member is applied directly to the emitting face. The compliant member is elastically deformed against the crimped terminal to match at least a portion of the contour of the crimped terminal. The acoustic signals pass from the emitting face through the compliant member into the crimped terminal during the testing phase.

In a further embodiment, a post-crimp inspection device is provided that includes first and second arms with an inspection zone being defined between the first and second arms configured to receive a crimped terminal. At least one of the first and second arms is movable toward the crimped terminal during a testing phase. A first ultrasonic transducer assembly is coupled to the first arm. The first ultrasonic transducer assembly has a transmitting transducer transmitting acoustic signals toward the crimped terminal. The first ultrasonic transducer assembly has an emitting face through which the acoustic signals are emitted. The first ultrasonic transducer assembly has a first compliant member applied directly to the emitting face. The first compliant member is elastically deformed against the crimped terminal. The acoustic signals pass from the emitting face through the first compliant member into the crimped terminal during the testing phase. A second ultrasonic transducer assembly is coupled to the second arm. The second ultrasonic transducer assembly has a receiving transducer receiving the acoustic signals. The second ultrasonic transducer assembly has a receiving face through which the acoustic signals are received. The second ultrasonic transducer assembly has a second compliant member applied directly to the receiving face that is elastically deformed against the crimped terminal. The acoustic signals pass from the crimped terminal through the second compliant member into the receiving transducer during the testing phase.

### BRIEF DESCRIPTION OF THE DRAWINGS

FIG. 1 is a perspective view of a terminal crimping device according to an exemplary embodiment.

FIG. 2 illustrates a portion of the terminal crimping device showing an anvil and ram used to form a crimped terminal during a crimping operation.

FIG. 3 illustrates a portion of a post-crimp inspection device formed in accordance with an exemplary embodiment.

FIG. 4 illustrates a portion of the post-crimp inspection device in a closed state.

FIG. 5 illustrates a portion of the post-crimp inspection device in accordance with an exemplary embodiment.

FIG. 6 illustrates a portion of a post-crimp inspection device formed in accordance with an exemplary embodiment.

FIG. 7 illustrates a portion of the post-crimp inspection device formed in accordance with an exemplary embodiment.

### DETAILED DESCRIPTION OF THE INVENTION

Embodiments described herein provide a post-crimp inspection device that uses ultrasonic transducers to monitor crimp quality. The post-crimp inspection device tests a crimped terminal, after the terminal has been crimped to the wire, for certain crimp characteristics, such as crimp height, crimp geometry, crimp symmetry, roll, twist, flash, wire uniformity throughout the crimped terminal, missing strands, and the like. The post-crimp inspection device uses compliant member(s) to create an acoustic interface with the crimped terminal. The compliant member(s) allow the acoustic signals to be transmitted between ultrasonic transducer(s) and the crimped terminal. The compliant member(s) allow the same post-crimp inspection device to test and inspect different kinds of crimped terminals, such as crimped terminals from different terminal crimping devices, different sized crimped terminals, different types of crimped terminals, and the like because the compliant members conform to the contour of the crimped terminal. The Figures illustrate exemplary embodiments of a terminal crimping device that is used to form a crimped terminal as well as exemplary embodiments of a post-crimp inspection device used to inspect crimped terminals.

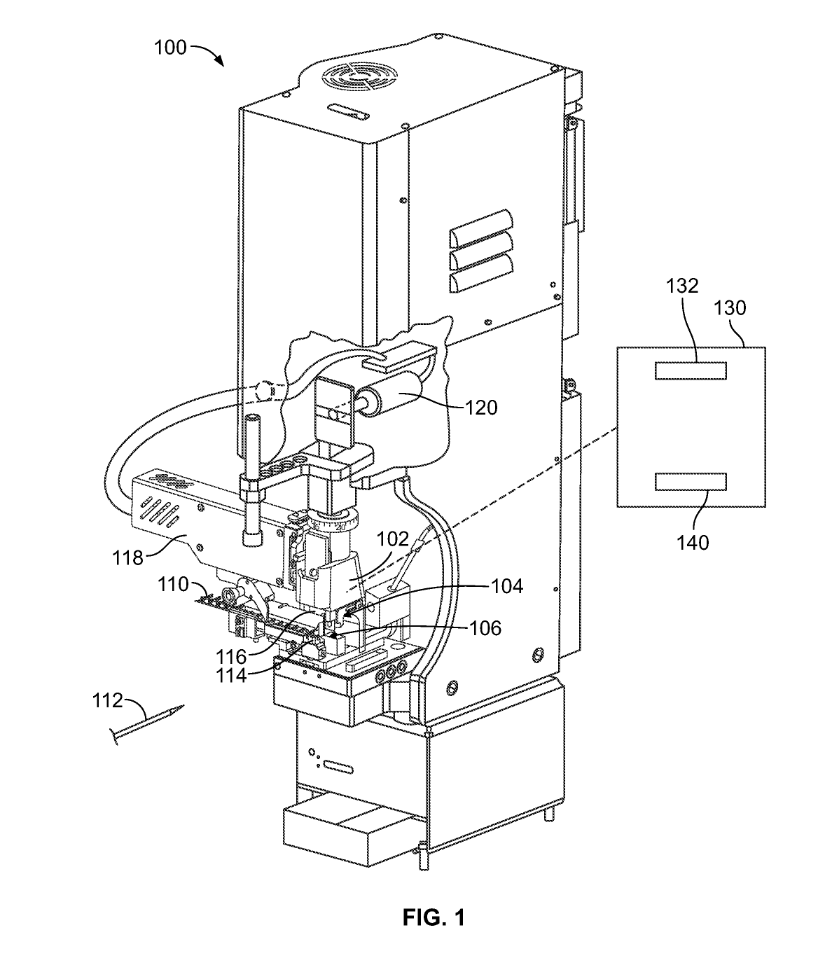

FIG. 1 is a perspective view of a terminal crimping device 100 formed in accordance with an exemplary embodiment. The terminal crimping device 100 is used for crimping terminals to wires. In the illustrated embodiment, the terminal crimping device 100 is a bench machine having an applicator 102. Alternatively, the terminal crimping device 100 may be another type of crimping machine, such as a lead maker or a hand tool. In an exemplary embodiment, as described in further detail below, the post-crimp inspection device may be configured to inspect different kinds of crimped terminals, such as crimped terminals that are crimped using an applicator a lead-maker and a hand-tool.

The terminal crimping device 100 includes crimp tooling 104 that is used to form the terminal during the pressing or crimping operation. The terminal crimping device 100 has a terminating zone or crimp zone 106 defined between the crimp tooling 104. Electrical connectors or terminals 110 and an end of a wire 112 are presented in the crimp zone 106 between the crimp tooling 104. In an exemplary embodiment, the crimp tooling 104 used for crimping includes an anvil 114 and a ram 116. The anvil 114 and/or the ram 116 may have removable dies that define the shape or profile of the terminal 110 during the crimping process. Changing of the dies may change the shape of the crimped terminal. The dies may be changed to accommodate a larger wire and larger terminal. In an exemplary embodiment, as described in further detail below, the post-crimp inspection device may be configured to inspect different kinds of crimped terminals, such as crimped terminals that are crimped with different dies that are swapped into the anvil 114 and/or ram 116. In the illustrated embodiment, the anvil 114 is a stationary component of the applicator 102, and the ram 116 represents a movable component. Alternatively, both the ram 116 and the anvil 114 may be movable. For example, with hand tools, typically both halves of the crimp tooling 104 are closed toward each other during the crimping operation.

The terminal crimping device 100 includes a feeder device 118 that is positioned to feed the terminals 110 to the crimp zone 106. The feeder device 118 may be positioned adjacent to the mechanical crimp tooling 104 in order to deliver the terminals 110 to the crimp zone 106. The terminals 110 may be guided to the crimp zone 106 by a feed mechanism to ensure proper placement and/orientation of the terminal 110 in the crimp zone 106. The wire 112 is delivered to the crimp zone 106 by a wire feeder (not shown).

During a crimping operation, the ram 116 of the applicator 102 is driven through a crimp stroke by a driving mechanism 120 of the terminal crimping device 100 initially towards the stationary anvil 114 and finally away from the anvil 114. Thus, the crimp stroke has both a downward component and an upward component. The crimping of the terminal 110 to the wire 112 occurs during the downward component of the crimp stroke. During the crimping operation, a terminal 110 is loaded onto the anvil 114 in the crimp zone 106, and an end of the wire 112 is fed within a crimp barrel of the terminal 110. The ram 116 is then driven downward along the crimp stroke towards the anvil 114. The ram 116 engages the crimp barrel of the terminal 110 and deforms (e.g. folds or rolls) the ends of the crimp barrel inward around the wire 112. The crimp tooling 104 crimps the terminal 110 onto the wire 112 by compressing or pinching the terminal 110 between the ram 116 and the anvil 114. The ram 116 then returns to an upward position. As the ram 116 moves upward, the ram 116 releases or separates from the terminal 110. In an exemplary embodiment, the resilient nature of the terminal 110 and/or wires 112 causes the terminal 110 to rebound slightly from the bottom dead center of the downward portion of the crimp stroke. The elastic yield or spring back of the terminal 110 will follow the ram 116 for a portion of the return or upward part of the stroke of the ram 116 until the terminal 110 reaches a final or stable size. At such point, the terminal 110 has a particular crimp height measured between the bottom and top most points of the terminal 110.

The operation of the terminal crimping device 100 is controlled by a control module 130. For example, the control module 130 may control the operation of the driving mechanism 120. The control module 130 may control the operation of the feeder device 118 and synchronizes the timing of the crimp stroke with the timing of a feed stroke of the feeder device 118. In an exemplary embodiment, the control module 130 includes a crimp quality module 132 that determines a crimp quality of the particular crimp. The terminal 110 may be discarded if the crimp quality does not meet certain specifications. In an exemplary embodiment, the crimp quality module 132 determines a crimp height of the terminal as a measure of crimp quality. The crimp quality module 132 may determine crimp quality based on other characteristics in addition to, or in the alternative to, the crimp height, such as a force measurement or force profile of the terminal during the crimp. The post-crimp inspection device may be used to calibrate and/or validate the analysis of the crimp quality module 132.

In an exemplary embodiment, the control module 130 includes an ultrasound module 140 for transmitting and receiving ultrasonic acoustic signals. The ultrasound module 140 may cause acoustic signals to be transmitted through the terminal 110 and the wire 112 during the crimping operation. The crimp quality module 132 may determine crimp quality based on the acoustic signals transmitted through the terminal 110 and the wire 112. The crimp quality module 132 may determine a crimp height of the terminal 110 based on the acoustic signals transmitted through the terminal 110 and the wire 112. The crimp quality module 132 may determine a shape of the crimped terminal based on the acoustic signals transmitted through the terminal 110 and the wire 112. The ultrasound module 140 may cause acoustic signals to be transmitted through the ram 116 and/or the anvil 114 in addition to the terminal 110 and the wire 112 during the crimping operation. For example, in some embodiments, the acoustic signals may be generated at a transducer in the ram 116, transmitted through the ram 116, through the terminal 110, through the wire 112 and through the anvil 114 and then received at a transducer in the anvil 114. In some embodiments, the acoustic signals may be generated at a transducer in the anvil 114, transmitted through the anvil 114, through the terminal 110, through the wire 112 and through the ram 116 and then received at a transducer in the ram 116. In some embodiments, the acoustic signals may be generated at a transducer in the ram 116, transmitted through the ram 116, through the terminal 110, through the wire 112 and then back through the ram 116 and then received at a transducer in the ram 116, which may be the same transducer that generated the acoustic signal. In some embodiments, the acoustic signals may be generated at a transducer in the anvil 114, transmitted through the anvil 114, through the terminal 110, through the wire 112 and then back through the anvil 114 and then received at a transducer in the anvil 114, which may be the same transducer that generated the acoustic signal.

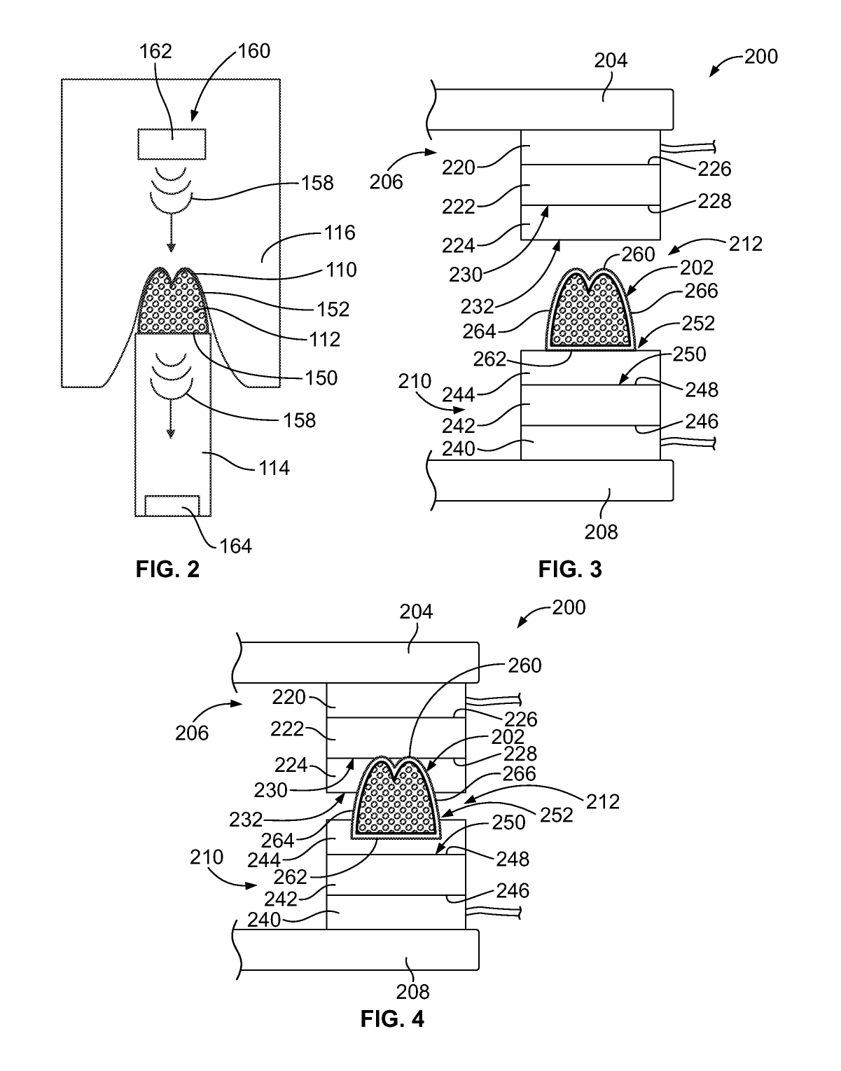

FIG. 2 illustrates a portion of the terminal crimping device 100 showing the anvil 114 and the ram 116 used to form the crimp during the crimping operation. The crimp tooling 104 forms an F-crimp in the illustrated embodiment; however other shape crimp tooling or dies may form crimps having other shapes in alternative embodiments.

The anvil 114 has a support surface 150 used to support the terminal 110. In the illustrated embodiment, the support surface 150 is flat and horizontal; however the support surface 150 may have other shapes and/orientations in alternative embodiments. The terminal 110 rests on the support surface 150 as the ram 116 is moved through the crimp stroke.

The ram 116 has a forming surface 152 that engages the terminal 110 during the crimping process. The forming surface 152 presses the sidewalls of the terminal barrel inward during the crimping process. The forming surface 152 compresses the sidewalls against the wire 112 during the crimping process. When the ram 116 is in contact with the terminal 110, acoustic signals 158 may be transmitted across the forming surface 152 into the terminal 110 and wire 112. The acoustic signals 158 may be transmitted across the support surface 150 into the anvil 114. The acoustic signals 158 may be reflected at the interfaces defined at the forming surface 152 and support surface 150.

In an exemplary embodiment, the ultrasound module 140 (shown in FIG. 1) includes one or more ultrasonic transducers 160 that transmit and/or receive acoustic signals 158 in the ultrasonic frequency range. In the illustrated embodiment, the ultrasound module 140 includes an ultrasonic transmitting transducer 162 and an ultrasonic receiving transducer 164. The ultrasonic transmitting transducer 162 is coupled to the ram 116, while the ultrasonic receiving transducer 164 is coupled to the anvil 114. In other embodiments, the ultrasonic receiving transducer 164 may be coupled to the ram 116 and/or the ultrasonic transmitting transducer 162 may be coupled to the anvil 114. In other embodiments, rather than having dedicated transmitting and receiving transducers, either or both of the transducers 162, 164 may be capable of transmitting and receiving the acoustic signals 158. In other embodiments, only one transducer 162 or 164 is needed that is capable of transmitting and receiving the acoustic signals 158. The ultrasonic transducers 160 may be coupled to an outer surface of the crimp tooling 104. Alternatively, the ultrasonic transducers 160 may be embedded within the crimp tooling 104. The ultrasonic transducers 160 are ultrasonically coupled to the crimp tooling 104, wherein the acoustic signals 158 may be transmitted to or from the ultrasonic transducers 160 to or from the crimp tooling 104. The ultrasonic transducers 160 are ultrasonically coupled to the terminal 110 and wire 112 via the crimp tooling 104.

In an exemplary embodiment, the ultrasonic transducers 160 are piezoelectric transducers that convert electrical energy into sound. The piezoelectric transducers change size when a voltage is applied thereto. The ultrasound module 140 includes electric circuitry coupled to the ultrasonic transmitting transducer 162 to supply an alternating current across the ultrasonic transducer 162 to cause oscillation at very high frequencies to produce very high frequency sound waves. The ultrasonic receiving transducer 164 generates a voltage when force is applied thereto from the acoustic signals 158 and the electric signal generated at the ultrasonic receiving transducer 164 is transmitted by electric circuitry coupled thereto to the ultrasound module 140 and/or the crimp quality module 132 (shown in FIG. 1). Other types of ultrasonic transducers 160 other than piezoelectric transducers may be used in alternative embodiments, such as magnetostrictive transducers.

In an exemplary embodiment, the ultrasound module 140 and/or crimp quality module 132 is/are used to analyze certain crimp characteristics, such as crimp height, crimp geometry, crimp symmetry, roll, twist, flash, wire uniformity throughout the crimped terminal, missing strands, and the like. For example, the ultrasound module 140 generates the ultrasonic acoustic signal 158 at the transmitting transducer 162. The acoustic signal 158 travels through the crimp tooling 104 and crimped terminal 110 and wire 112 in the form of a longitudinal sound wave, however the wave may be propagated in any direction. The ultrasonic receiving transducer 164 receives the acoustic signal 158 and converts such signal to an electrical signal for processing, such as by the crimp quality module 132. Such process may be repeated approximately 500 or more times per crimp cycle. In an exemplary embodiment, the post-crimp inspection device may be used to calibrate and/or validate the analysis of the crimp quality module 132.

FIG. 3 illustrates a portion of a post-crimp inspection device 200 formed in accordance with an exemplary embodiment and in an open state. FIG. 4 illustrates a portion of the post-crimp inspection device 200 in a closed state and inspecting a crimped terminal 202. The post-crimp inspection device 200 is used to inspect the crimped terminal 202 after the terminal 110 has been crimped to the wire 112 for certain crimp characteristics, such as crimp height, crimp geometry, crimp symmetry, roll, twist, flash, wire uniformity throughout the crimped terminal 202, missing strands, and the like. In an exemplary embodiment, the post-crimp inspection device 200 is used to test and inspect different kinds of crimped terminals 202, such as crimped terminals from different terminal crimping devices, different sized crimped terminals, different types of crimped terminals, and the like.

The post-crimp inspection device 200 includes a first arm 204 holding a first ultrasonic transducer assembly 206 and a second arm 208 holding a second ultrasonic transducer assembly 210. An inspection zone 212 is defined between the first and second arms 204, 208 and between the first and second ultrasonic transducer assemblies 206, 210. The crimped terminal 202 is received in the inspection zone 212.

During a testing phase, at least one of the first and second arms 204, 208 are movable toward the crimped terminal 202 from the open state (shown in FIG. 3) to the closed state (shown in FIG. 4). As the first arm 204 and/or the second arm 208 are moved, the transducer assemblies 206 and/or 210 are likewise moved into position relative to the crimped terminal 202 for inspection thereof. Optionally, the first arm 204 and/or second arm 208 may have a limited amount of movement that restricts the relative positions of the first and second arms 204, 208 in the closed state to ensure that the crimped terminal 202 is not compressed during the testing phase. Optionally, the post-crimp inspection device 200 may be part of a machine having a actuator that moves the first and/or second arms 204, 208, such as in a similar way as the applicator 102 (shown in FIG. 1) moves the ram 116 (shown in FIG. 1) during the crimping process. In an alternative embodiment, rather than being an electrically actuated machine, the post-crimp inspection device 200 may be a manual device, such as a hand tool or a machine having a hand operated lever that allows an operator to move the first arm 204 and/or the second arm 208 during the testing phase.

The first ultrasonic transducer assembly 206 includes a first ultrasonic transducer 220. The first ultrasonic transducer assembly 206 includes a mounting block 222 and a first compliant member 224 mounted to the mounting block 222. The mounting block 222 and compliant member 224 are ultrasonically coupled to the ultrasonic transducer 220. Ultrasonic acoustic signals are configured to pass through the mounting block 222 and the complaint member 224 to and/or from the ultrasonic transducer 220. The ultrasonic transducer 220, mounting block 222 and the compliant member 224 are all supported by, and movable with, the first arm 204. Optionally, the ultrasonic transducer 220 is coupled to the first arm 204, the mounting block 222 is coupled to the ultrasonic transducer 220 and the compliant member 224 is coupled to the mounting block 222. Alternatively, the mounting block 222 may be coupled to the first arm 204 and the ultrasonic transducer 220 and compliant member 224 may then be coupled to the mounting block 222.

In an exemplary embodiment, the first ultrasonic transducer 220 is a transmitting transducer configured to transmit acoustic signals toward the crimped terminal 202. The first ultrasonic transducer 220 may be referred to hereinafter as a transmitting transducer 220. The first ultrasonic transducer 220 may be configured to receive acoustic signals in addition to, or in the alternative to, transmitting the acoustic signals.

The mounting block 222 has a first side 226 and a second side 228. The transmitting transducer 220 is coupled to the first side 226. The first compliant member 224 is coupled to the second side 228. In an exemplary embodiment, the second side 228 defines an emitting face 230 and acoustic signals may be emitted from the emitting face 230 into the first compliant member 224. The acoustic signals are emitted through the first compliant member 224 into the crimped terminal 202. In alternative embodiments, the first ultrasonic transducer assembly 206 may be provided without the mounting block 222, but rather the first compliant member 224 may be applied directly to the transducer 220.

The mounting block 222 is manufactured from a material having good acoustic properties such that the acoustic signals may be efficiently transmitted through the mounting block 222 from the transmitting transducer 220 to the compliant member 224. For example, the mounting block 222 may be manufactured from a metal material. In an exemplary embodiment, the mounting block 222 is a rigid body used to support the compliant member 224. While the mounting block 222 is shown as being generally rectangular in cross section, it is realized that the mounting block 222 may have other shapes in alternative embodiments. For example, the first and/or second sides 226, 228 may be non-planar and/or non-parallel to one another.

The compliant member 224 is positioned between the transmitting transducer 220 and the crimped terminal 202. In the illustrated embodiment, the compliant member 224 is applied directly to the second side 228 or emitting face 230 of the mounting block 222. The compliant member 224 is elastically deformable. Optionally, the compliant member 224 may be an elastomer coupler.

The compliant member 224 is configured to engage the crimped terminal 202 and conform to a contour of the crimped terminal 202. During use, the compliant member 224 is pressed against the crimped terminal 202 to ensure that the first ultrasonic transducer assembly 206 is adequately acoustically coupled to the crimped terminal 202 such that the acoustic signals may be transmitted between the transmitting transducer 220 and the crimped terminal 202.

The compliant member 224 may have any shape to conform to the second side 228. Optionally, the compliant member 224 may have a uniform thickness, however the compliant member 224 may have a non-uniform thickness in alternative embodiments. For example, the compliant member 224 maybe thicker at the outer sides thereof and/or at a central location thereof.

The compliant member 224 has a conforming surface 232 generally opposite the mounting block 222. The conforming surface 232 is configured to engage the crimped terminal 202 and conform to the contour of the crimped terminal 202, such as shown in FIG. 4. The conforming surface 232 does not necessarily need to match the contour of the crimped terminal 202 in a normal or un-deformed state (shown in FIG. 3). The elastic nature of the compliant member 224 allows the conforming surface 232 to conform to the contour of the crimped terminal 202 when the first ultrasonic transducer assembly 206 is pressed against the crimped terminal 202. In an exemplary embodiment, the first ultrasonic transducer assembly 206 is pressed against the crimped terminal 202 with sufficient force to deform the compliant member 224 to conform to the contour of the crimped terminal 202, but not with great enough pressure to deform or change the shape of the crimped terminal 202.

In an exemplary embodiment, the second side 228 of the mounting block 222 does not need to have a contour that matches the contour of the crimped terminal 202 as the compliant member 224 is used to conform to the contour of the crimped terminal 202. The compliant member 224 allows the post-crimp inspection device 200 to test and inspect different kinds of crimped terminals, such as crimped terminals from different terminal crimping devices, different sized crimped terminals, different types of crimped terminals, and the like because of the compliant member 224 conforms to the contour of the crimped terminal 202. The compliant member 224 is configured to receive and be ultrasonically coupled to crimped terminals 202 that are crimped using different crimp tooling, including crimped terminals 202 that have slight variations or drastic variations in the profile thereof. The post-crimp inspection device 200 is able to inspect different types of terminals without deforming or changing the shape of the crimped terminals during the testing phase (e.g. the crimp height does not change during the testing phase so that the post-crimp inspection device 200 is able to accurately measure the crimp height of the crimped terminal 202).

The second ultrasonic transducer assembly 210 includes a second ultrasonic transducer 240. The second ultrasonic transducer assembly 210 includes a mounting block 242 and a second compliant member 244 mounted to the mounting block 242. The mounting block 242 and compliant member 244 are ultrasonically coupled to the ultrasonic transducer 240. Ultrasonic acoustic signals are configured to pass through the mounting block 242 and the complaint member 244 to and/or from the ultrasonic transducer 240. The ultrasonic transducer 240, mounting block 242 and the compliant member 244 are all supported by, and movable with, the second arm 204. Optionally, the ultrasonic transducer 240 is coupled to the second arm 204, the mounting block 242 is coupled to the ultrasonic transducer 240 and the compliant member 244 is coupled to the mounting block 242. Alternatively, the mounting block 242 may be coupled to the second arm 204 and the ultrasonic transducer 240 and compliant member 244 may then be coupled to the mounting block 242.

In an exemplary embodiment, the second ultrasonic transducer 240 is a receiving transducer configured to receive acoustic signals that have passed through the crimped terminal 202. The second ultrasonic transducer 240 may be referred to hereinafter as a receiving transducer 240. The acoustic signals received at the receiving transducer 240 are converted to electrical signals and analyzed, such as by a crimp quality module. The electrical signals may be compared to the electrical signals received by the ultrasonic receiving transducer 164 (shown in FIG. 2) for calibration and/or validation of the crimp quality module 132 (shown in FIG. 1). The second ultrasonic transducer 240 may be configured to transmit acoustic signals in addition to, or in the alternative to, receiving the acoustic signals.

The mounting block 242 has a first side 246 and a second side 248. The transmitting transducer 240 is coupled to the first side 246. The second compliant member 244 is coupled to the second side 248. In an exemplary embodiment, the second side 248 defines a receiving face 250 and acoustic signals may be received through the receiving face 250 into the mounting block 242. The acoustic signals are received after passing through the second compliant member 244 and the crimped terminal 202. In alternative embodiments, the second ultrasonic transducer assembly 210 may be provided without the mounting block 242, but rather the second compliant member 244 may be applied directly to the transducer 240.

The mounting block 242 is manufactured from a material having good acoustic properties such that the acoustic signals may be efficiently transmitted through the mounting block 242 from the compliant member 244 to the receiving transducer 240. For example, the mounting block 242 may be manufactured from a metal material. In an exemplary embodiment, the mounting block 242 is a rigid body used to support the compliant member 244. While the mounting block 242 is shown as being generally rectangular in cross section, it is realized that the mounting block 242 may have other shapes in alternative embodiments. For example, the first and/or second sides 246, 248 may be non-planar and/or non-parallel to one another. The mounting block 242 may be shaped differently than the mounting block 222.

The compliant member 244 is positioned between the transmitting transducer 240 and the crimped terminal 202. In the illustrated embodiment, the compliant member 244 is applied directly to the second side 248 or receiving face 250 of the mounting block 242. The compliant member 244 is elastically deformable. Optionally, the compliant member 244 may be an elastomer coupler.

The compliant member 244 is configured to engage the crimped terminal 202 and conform to a contour of the crimped terminal 202. During use, the compliant member 244 is pressed against the crimped terminal 202 to ensure that the second ultrasonic transducer assembly 210 is adequately acoustically coupled to the crimped terminal 202 such that the acoustic signals may be transmitted between the transmitting transducer 240 and the crimped terminal 202.

The compliant member 244 may have any shape to conform to the second side 248. Optionally, the compliant member 244 may have a uniform thickness, however the compliant member 244 may have a non-uniform thickness in alternative embodiments. For example, the compliant member 244 maybe thicker at the outer sides thereof and/or at a central location thereof. The compliant member 244 may be shaped differently than the compliant member 224.

The compliant member 244 has a conforming surface 252 generally opposite the mounting block 242. The conforming surface 252 is configured to engage the crimped terminal 202 and conform to the contour of the crimped terminal 202. The conforming surface 252 does not necessarily need to match the contour of the crimped terminal 202 in a normal or un-deformed state. The elastic nature of the compliant member 244 allows the conforming surface 252 to conform to the contour of the crimped terminal 202 when the second ultrasonic transducer assembly 210 is pressed against the crimped terminal 202. In an exemplary embodiment, the second ultrasonic transducers assembly 210 is pressed against the crimped terminal 202 with sufficient force to deform the compliant member 244 to conform to the contour of the crimped terminal 202, but not with great enough pressure to deform or change the shape of the crimped terminal 202.

In an exemplary embodiment, the second side 248 of the mounting block 242 does not need to have a contour that matches the contour of the crimped terminal 202 as the compliant member 244 is used to conform to the contour of the crimped terminal 202. The compliant member 244 allows the post-crimp inspection device 200 to test and inspect different kinds of crimped terminals, such as crimped terminals from different terminal crimping devices, different sized crimped terminals, different types of crimped terminals, and the like because of the compliant member 244 conforms to the contour of the crimped terminal 202. The compliant member 244 is configured to receive and be ultrasonically coupled to crimped terminals 202 that are crimped using different crimp tooling, including crimped terminals 202 that have slight variations or drastic variations in the profile thereof. The post-crimp inspection device 200 is able to inspect different types of terminals without deforming or changing the shape of the crimped terminals during the testing phase (e.g. the crimp height does not change during the testing phase so that the post-crimp inspection device 200 is able to accurately measure the crimp height of the crimped terminal 202).

The crimped terminal 202 may have any shape or profile depending on the particular terminal 110 and gauge of the wire 112. In the illustrated embodiment, the crimped terminal 202 has a top 260, a bottom 262, a first side 264 and a second side 266. The bottom 262 may be flat, or alternatively may be curved. The sides 264, 266 may be curved or may be generally planar. The sides 264, 266 may be angled inward toward the top 260. The top 260 may be flat or may be curved. The top 260 may be folded inward into the wire 112 at a center of the top 260.

In an exemplary embodiment, the first compliant member 224 engages the top 260 and the first and second sides 264, 266, while the second compliant member 244 engages the bottom 262 and the first and second sides 264, 266. The compliant members 224, 244 may engage different parts of the crimped terminal 202 in other embodiments. Optionally, post-crimp inspection device 200 may receive the crimped terminal 202 in any orientation (e.g. any rotational orientation) and does not require the crimped terminal 202 to be precisely positioned within the inspection zone 212. In an exemplary embodiment, the first and second compliant members 224, 244 do not engage one another. A direct ultrasonic path is not created between the compliant members 224, 244, but rather the ultrasonic path is created only through the crimped terminal 202.

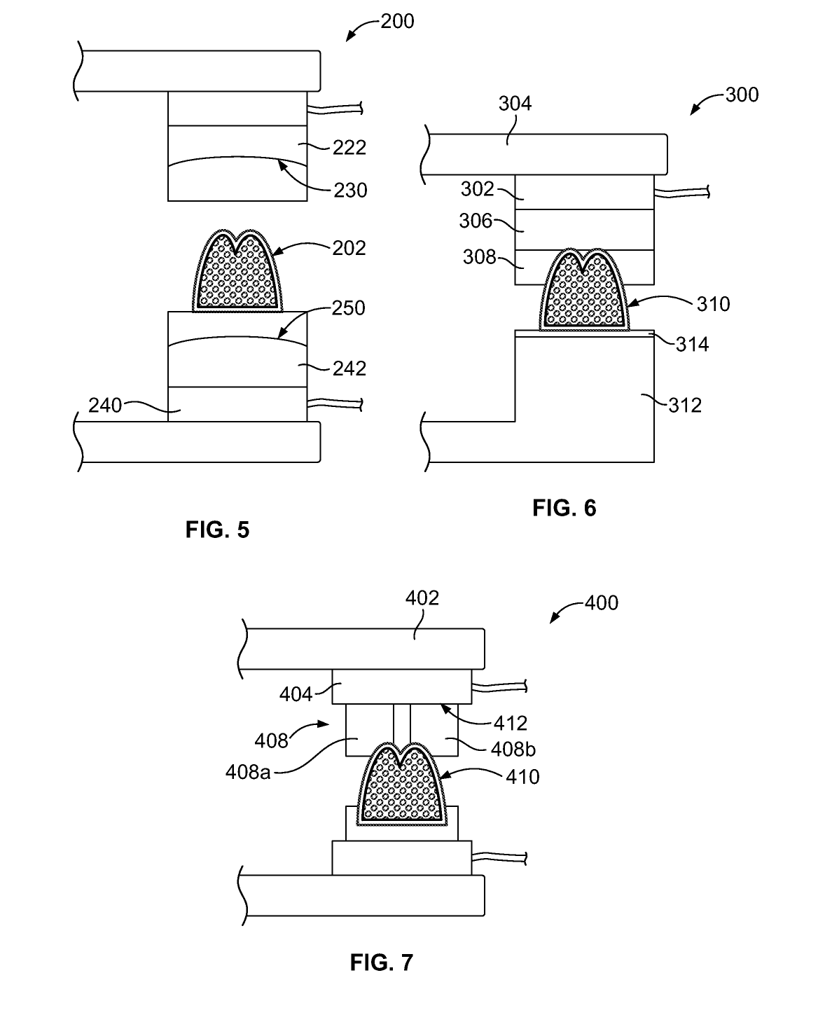

FIG. 5 illustrates a portion of the post-crimp inspection device 200 showing the emitting face 230 and receiving face 250 of the mounting blocks 222, 242, respectively, having curved surfaces. The emitting face 230 has a concave surface to direct or focus the acoustic signals toward the crimped terminal 202. The receiving face 250 has a convex surface to direct or focus the acoustic signals toward the receiving transducer 240. The post-crimp inspection device 200 may have other features that filter and/or direct the acoustic signals to reduce the signal-to-noise ratio of the received signals.

FIG. 6 illustrates a portion of a post-crimp inspection device 300 formed in accordance with an exemplary embodiment. The post-crimp inspection device 300 is similar to the post-crimp inspection device 200, however the post-crimp inspection device 300 includes a single ultrasonic transducer 302 that is able to both transmit and receive ultrasonic acoustic signals.

The post-crimp inspection device 300 includes a first arm 304 that supports the ultrasonic transducer 302. The post-crimp inspection device 300 includes a mounting block 306 and a compliant member 308. A crimped terminal 310 is supported by a second arm 312. The first arm 304 and/or the second arm 312 are moved relative to one another to press the compliant member 308 into the crimped terminal 310. The transducer 302 transmits acoustic signals through the mounting block 306 and through the compliant member 308 into the crimped terminal. The acoustic signals are reflected back toward the transducer 302, such as from the second arm 312. Optionally, an acoustic reflector 314 may be provided along the second arm 312 that reflects the acoustic signals back toward the transducer 302. An air interface may be used to reflect the acoustic signals. The acoustic signals received at the transducer 302 are converted to electrical signals and analyzed.

FIG. 7 illustrates a portion of the post-crimp inspection device 400 formed in accordance with an exemplary embodiment. The post-crimp inspection device 400 is similar to the post-crimp inspection devices 200, 300, however the post-crimp inspection device 400 does not use a mounting block to support a transducer and/or compliant member.

The post-crimp inspection device 400 includes a first arm 402 that supports an ultrasonic transducer 404. A compliant member 408 is applied directly to the transducer 404. The transducer 404 transmits acoustic signals through the compliant member 408 into a crimped terminal 410. The transducer 404 defines an emitting face 412 through which the acoustic signals are emitted. The compliant member 408 is applied directly to the emitting face 412.

In an exemplary embodiment, the compliant member 408 includes multiple compliant member segments 408a, 408b selectively positioned to interface with select portions of the crimped terminal 410. For example, the compliant members 408 are positioned along the peaks of the top of the crimped terminal 410 and do not extend entirely into the valley defined at the top of the crimped terminal 410. The acoustic signals are thus forced to be transmitted into certain area(s) of the crimped terminal 410, such as the tallest portion of the crimped terminal 410 or the area of the crimped terminal 410 that creates less reflections, echoes and/or noise. Any number of compliant members may be provided in alternative embodiments.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A post-crimp inspection device comprising:
first and second arms with an inspection zone being defined between the first and second arms configured to receive a crimped terminal, at least one of the first and second arms being movable toward the crimped terminal during a testing phase;
an ultrasonic transducer coupled to the first arm, the ultrasonic transducer transmitting acoustic signals toward the crimped terminal; and
a compliant member positioned between the ultrasonic transducer and the crimped terminal, the ultrasonic transducer being ultrasonically coupled to the crimped terminal via the compliant member.

2. The post-crimp inspection device of claim 1, wherein the compliant member conforms to a contour of the crimped terminal.

3. The post-crimp inspection device of claim 1, wherein the compliant member is applied directly to the ultrasonic transducer.

4. The post-crimp inspection device of claim 1, further comprising a mounting block having a first side and a second side, the ultrasonic transducer coupled to the first side, the compliant member coupled to the second side.

5. The post-crimp inspection device of claim 4, wherein the second side defines an emitting face, the acoustic signals being emitted from the emitting face, the emitting face having a contour that does not match a contour of the crimped terminal, the compliant member being applied directly to the emitting face, the compliant member being elastically deformed against the crimped terminal to match at least a portion of the contour of the crimped terminal.

6. The post-crimp inspection device of claim 4, wherein the second side is concave to focus the acoustic signals inward toward the crimped terminal.

7. The post-crimp inspection device of claim 1, wherein the compliant member is configured to receive and be ultrasonically coupled to crimped terminals that are crimped using different crimp tooling.

8. The post-crimp inspection device of claim 1, wherein the ultrasonic transducer defines a first ultrasonic transducer and the compliant member defines a first compliant member, the post-crimp inspection device further comprising:
a second ultrasonic transducer coupled to the second arm, the second ultrasonic transducer receiving the acoustic signals; and
a second compliant member positioned between the second ultrasonic transducer and the crimped terminal, the crimped terminal being ultrasonically coupled to the second ultrasonic transducer via the second compliant member.

9. The post-crimp inspection device of claim 8, wherein the first and second compliant members do not touch one another.

10. The post-crimp inspection device of claim 8, wherein the crimped terminal includes a top, a bottom, a first side and a second side, the first compliant member engaging the top and the first and second sides, the second compliant member engaging the bottom and the first and second sides.

11. The post-crimp inspection device of claim 1, wherein the compliant member is an elastomer material.

12. A post-crimp inspection device comprising:
first and second arms with an inspection zone being defined between the first and second arms configured to receive a crimped terminal, at least one of the first and second arms being movable toward the crimped terminal during a testing phase;
an ultrasonic transducer assembly coupled to the first arm, the ultrasonic transducer assembly having a transmitting transducer transmitting acoustic signals toward the crimped terminal, the ultrasonic transducer assembly having an emitting face through which the acoustic signals are emitted, the emitting face having a contour that does not match a contour of the crimped terminal; and
a compliant member applied directly to the emitting face, the compliant member being elastically deformed against the crimped terminal to match at least a portion of the contour of the crimped terminal, the acoustic signals passing from the emitting face through the compliant member into the crimped terminal during the testing phase.

13. The post-crimp inspection device of claim 12, wherein the compliant member conforms to a contour of the crimped terminal.

14. The post-crimp inspection device of claim 12, wherein the transmitting transducer defines the emitting face.

15. The post-crimp inspection device of claim 12, wherein the ultrasonic transducer assembly comprises a mounting block having a first side and a second side, the ultrasonic transducer coupled to the first side, the compliant member coupled to the second side.

16. The post-crimp inspection device of claim 15, wherein the second side is concave to focus the acoustic signals inward toward the crimped terminal.

17. The post-crimp inspection device of claim 12, wherein the ultrasonic transducer defines a first ultrasonic transducer and the compliant member defines a first compliant member, the post-crimp inspection device further comprising:
a second ultrasonic transducer coupled to the second arm, the second ultrasonic transducer receiving the acoustic signals; and
a second compliant member positioned between the second ultrasonic transducer and the crimped terminal, the crimped terminal being ultrasonically coupled to the second ultrasonic transducer via the second compliant member.

18. A post-crimp inspection device comprising:
first and second arms with an inspection zone being defined between the first and second arms configured to receive a crimped terminal, at least one of the first and second arms being movable toward the crimped terminal during a testing phase;
a first ultrasonic transducer assembly coupled to the first arm, the first ultrasonic transducer assembly having a transmitting transducer transmitting acoustic signals toward the crimped terminal, the first ultrasonic transducer assembly having an emitting face through which the acoustic signals are emitted, the first ultrasonic transducer assembly having a first compliant member applied directly to the emitting face, the first compliant member being elastically deformed against the crimped terminal, the acoustic signals passing from the emitting face through the first compliant member into the crimped terminal during the testing phase; and
a second ultrasonic transducer assembly coupled to the second arm, the second ultrasonic transducer assembly having a receiving transducer receiving the acoustic signals, the second ultrasonic transducer assembly having a receiving face through which the acoustic signals are received, the second ultrasonic transducer assembly having a second compliant member applied directly to the receiving face, the second compliant member being elastically deformed against the crimped terminal, the acoustic signals passing from the crimped terminal through the second compliant member into the receiving transducer during the testing phase.

19. The post-crimp inspection device of claim 18, wherein the first and second compliant members conform to a contour of the crimped terminal.

20. The post-crimp inspection device of claim 18, wherein the first and second compliant members do not touch one another.

21. The post-crimp inspection device of claim 18, wherein the crimped terminal includes a top, a bottom, a first side and a second side, the first compliant member engaging the top and the first and second sides, the second compliant member engaging the bottom and the first and second sides.
